(19) United States
(12) Patent Application Publication
(10) Pub. No.: US 2010/0276920 A1
(43) Pub. Date: Nov. 4, 2010

(54) IDENTIFICATION CARD HAVING ONE OR MORE GRIPPING ELEMENTS

(76) Inventors: Clark Woodman, New York, NY (US); Donna Russo, Forest Hills, NY (US)

Correspondence Address: BUCKLEY, MASCHOFF & TALWALKAR LLC, 50 LOCUST AVENUE, NEW CANAAN, CT, 06840, US

(21) Appl. No.: 12/769,129

(22) Filed: Apr. 28, 2010

Related U.S. Application Data
(60) Provisional application No. 61/173,733, filed on Apr. 29, 2009.

(51) Int. Cl. B42D 15/00

(52) U.S. Cl. 283/75

(57) ABSTRACT

According to some embodiments, an identification card may be provided with one or more gripping elements. For example, a raised border portion might be provided on the card's front and/or back face adjacent to and extending along at lease some of the card's sides. As another example, notches might be etched into the sides of the identification card. As still another example, an array of indented, gripping dimple portions might be provided on the front and/or back faces of the identification card.

### CROSS REFERENCE TO RELATED APPLICATION

The present application claims priority under 35 U.S.C. § 119(e) to U.S. Provisional Patent Application No. 61/173,733 entitled “Identification Card Having One or More Gripping Elements” on Apr. 29, 2009. The entire content of that application is incorporated herein by reference.

### BACKGROUND

In some cases, a user may be asked to manipulate an identification card. For example, a user might need to quickly insert and withdraw a credit card from a card reader. As another example, a user or employee of a retailer may need to swipe a payment card through a card reader at a point-of-sale terminal. As still another example, a user might need to wave or pass a debit card over a contactless card reading device.

A typical identification card, however, is generally formed of smooth plastic, metal, or similar materials which may make it difficult for a user to effectively grip and manipulate the card in these ways. For example, his or her fingers may slip when trying to swipe the identification card through a card reader. As a result, the person may feel frustration or embarrassment when trying to use to card (especially when in the presence of other people, such as employees of a retailer). In addition, this may result in longer transaction time, longer line of patrons at the checkout counter, and adversely affect retailer revenues.

### BRIEF DESCRIPTION OF THE DRAWINGS

FIG. 1 is an top view of an identification card face having a gripping border according to some embodiments of the present invention.

FIG. 2 is a perspective view of an identification card having a gripping border according to some embodiments of the present invention.

FIG. 3 is a side cross-sectional view of an identification card having a gripping border according to some embodiments of the present invention.

FIG. 4 is a side cross-sectional view of an identification card having two gripping borders according to another embodiment of the present invention.

FIG. 5 is a perspective view of a portion of an identification card having gripping notches along the sides of the card according to some embodiments of the present invention.

FIG. 6 is an top view of an identification card face having an array of indented, gripping dimples according to some embodiments of the present invention.

FIG. 7 is a side cross-sectional view of an identification card having an array of indented, gripping dimples according to some embodiments of the present invention.

FIG. 8 is a side cross-sectional view of an identification card having two arrays of indented, gripping dimples according to some embodiments of the present invention.

FIG. 9 is an illustration of a tapered payment card in accordance with some embodiments of the present invention.

FIG. 10 is an illustration of a payment card in accordance with another embodiment of the present invention.

FIG. 11 is an illustration of a payment card having an array of dimple portions in accordance with still another embodiment of the present invention.

FIG. 12 is a perspective view of an identification card having a gripping border, an array of dimple portions, and a tray according to some embodiments of the present invention.

FIG. 13 is an top view of an identification card having a gripping border offset from the card sides according to some embodiments of the present invention.

FIG. 14 is an top view of an identification card having a non-contiguous gripping border offset from the card sides according to some embodiments of the present invention.

FIG. 15 is a side cross-sectional view of an identification card having different types of gripping borders according to some other embodiments of the present invention.

### DETAILED DESCRIPTION

In general, and for the purpose of introducing concepts of embodiments of the present invention, an “identification card” may be provided with one or more gripping elements. As used herein, the phrase “identification card” might refer to, for example, a payment card, a credit card, a debit card, a loyalty program card, a badge, a license, a passport card, a radio frequency apparatus, and/or a contactless card.

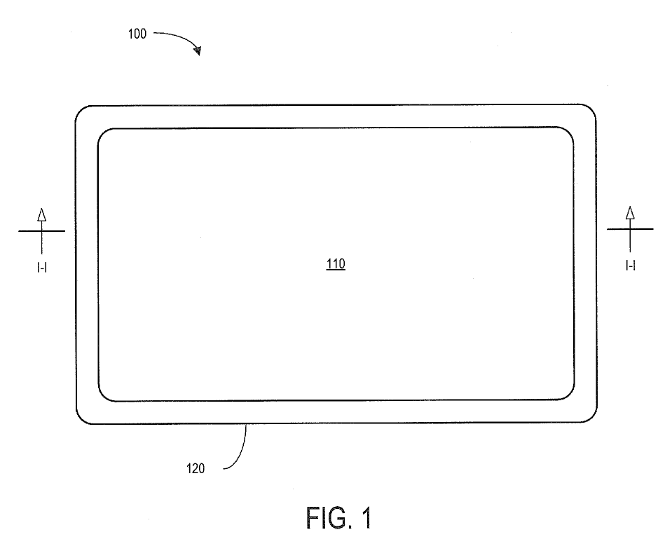

By way of example, FIG. 1 is an top view of an identification card face 100 having a raised gripping border 120 according to some embodiments of the present invention. In particular, illustrated is a substantially card-shaped body 110 having a front face, a back face, and four card sides (e.g., the four sides of the face 100 illustrated in FIG. 1).

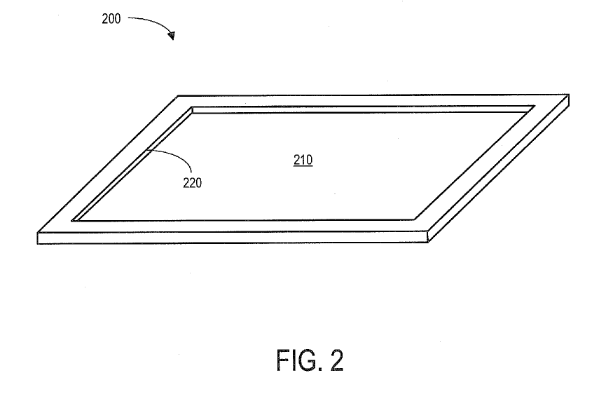

Note that FIG. 1 may represent either the front face or the back face of a substantially rectangular, substantially planar identification card. The raised border portion 120, located on at least one of the front face or back face, may be adjacent to and extend along one or more of the four card sides. According to the embodiment of FIG. 1, the raised border portion 120 forms a continuous frame extending along all four card sides (e.g., to create a “picture frame effect” for the identification card). FIG. 2 is a perspective view of an identification card 200 having a gripping border 220 around the outer edges of a card body 210 according to some embodiments of the present invention.

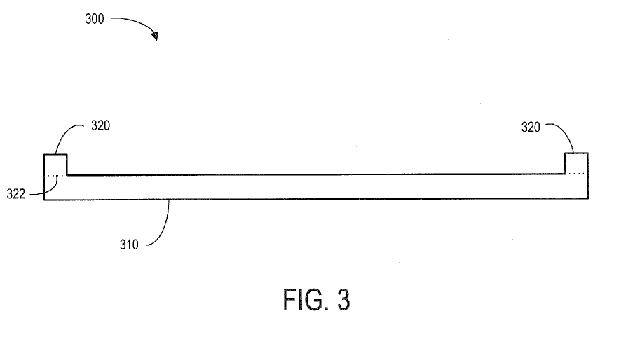

FIG. 3 is a side cross-sectional view of an identification card 300 having a main card body 310 and a gripping border 320 according to some embodiments of the present invention. The view of FIG. 3 may be associated with, for example, the cross-sectional view I-I illustrated in FIG. 1.

Note that the raised border portion 320 formed integral with the card body 310. Moreover, the card body 310 and/or raised border portion 320 may be formed of plastic, metal, rubber, and/or be coated with another material (e.g., a textured substance that improves a user's ability to grip the card body 310 and/or raised border portion 320). According to other embodiments, the border portion 320 is not integral with the card body 310 but instead is affixed to the card body 310 (e.g., via an adhesive). Such an approach is illustrated by the dotted lines 322 of FIG. 3. In this way, the card body 310 and border portion 320 might be formed of different materials.

Note that any of the embodiments described herein might be formed of a non-natural alloy of aluminum, silver and other metals with appropriate properties, such as strength, luminosity, and/or flexibility. Moreover, the embodiments may be formed using secondary materials such as hard woods, polymers, glasses, rubbers, jewels, fabrics, rocks, gemstones, and other naturally occurring materials individually or in combined nonnatural states.

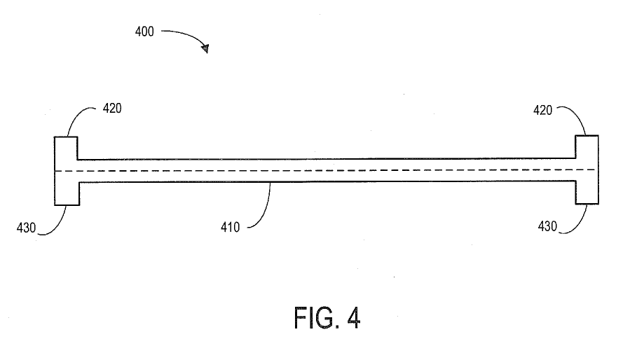

FIG. 4 is a side cross-sectional view of an identification card 400 having two gripping borders according to another embodiment of the present invention. That is, raised border portions 420, 430 are provided on both the front and back faces of the identification card body 410. As before, the border portions 420, 430 may be formed integral with the card body 410 or be attached to the card body 410. Moreover, according to some embodiments, a front face having with a raised border 420 is affixed to a back face having a raised border 430 (and the attached front and back faces comprise the main card body 410) as illustrated by the dashed line of FIG. 4. In this way, the card body 410 and border portions 420, 430 might be formed of different materials.

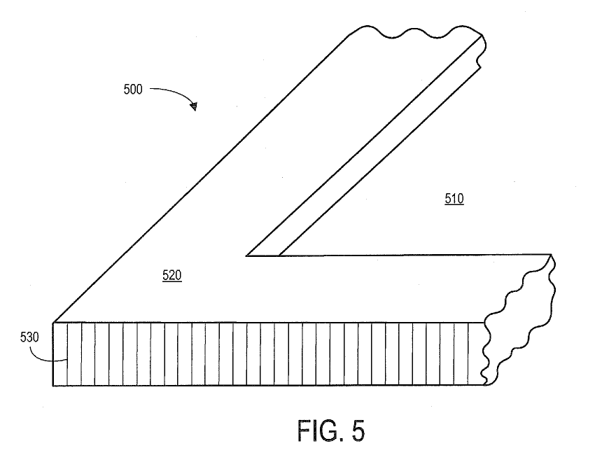

Note that other types of gripping elements might be used along with, or instead of, a raised border portion for an identification card. For example, FIG. 5 is a perspective view of a portion of an identification card 500 having a main body 510 and raised border 520. In this case, gripping notches 530 are also etched along the sides of the identification card 500 (similar to how notches may be etched into the side of a coin). The notches 530 may be formed on any number of sides of the identification card 500 and may be formed as grooves in the card sides extending from the front face to the back face of the identification card 500.

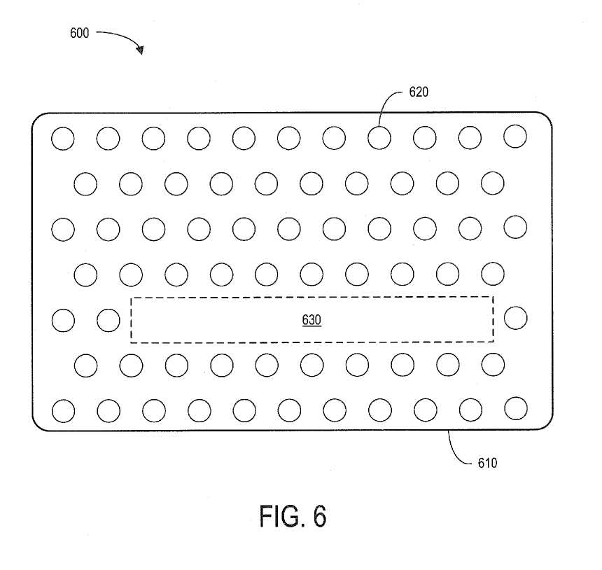

As another example, FIG. 6 is an top view of an identification card 600 having an a substantially card-shaped body 610 with a front face, a back face, and four card sides. In this case, an array of indented, gripping dimples 620 are provided, located on at least one of the front face or back face, according to some embodiments of the present invention. As used herein, an indented dimple may be any same (e.g., circular, square, triangular, or groove-shaped). Note that each dimple portion might not extend through the entire card body 610. According to some embodiments, however, some or all of the dimple portions 610 do extend through the card body 610 from the front face to the back face (e.g., the dimple portions 610 are actually holes in the card 600). In this case, the card body 610 and array of dimple portions 620 might take the form of a mesh or waffle screen.

The array of dimple portions 620 may cover substantially all of the front face or back face of the identification card 600. In some cases, an area 630 of the front or back face may be excluded from the array of dimple portions (e.g., to accommodate the printing of a credit card number or the inclusion of a magnetic stripe).

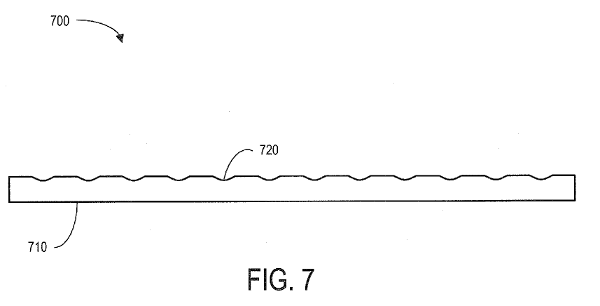

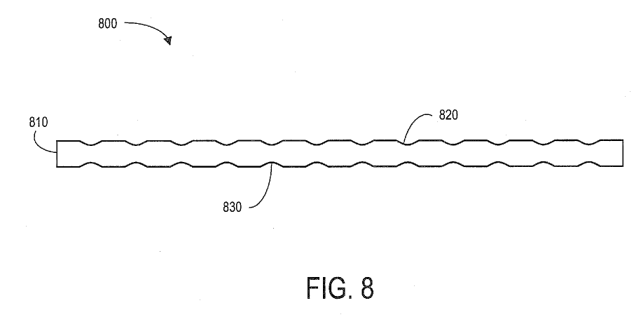

FIG. 7 is a side cross-sectional view of an identification card 700 having a card body 710 with an array of indented, gripping dimples 720 according to some embodiments of the present invention. The dimples 720 might be provided, for example, on either the front or back face of the identification card 700. As another example, FIG. 8 is a side cross-sectional view of an identification card 800 having a card body 810 with two arrays of indented, gripping dimples 820, 830.

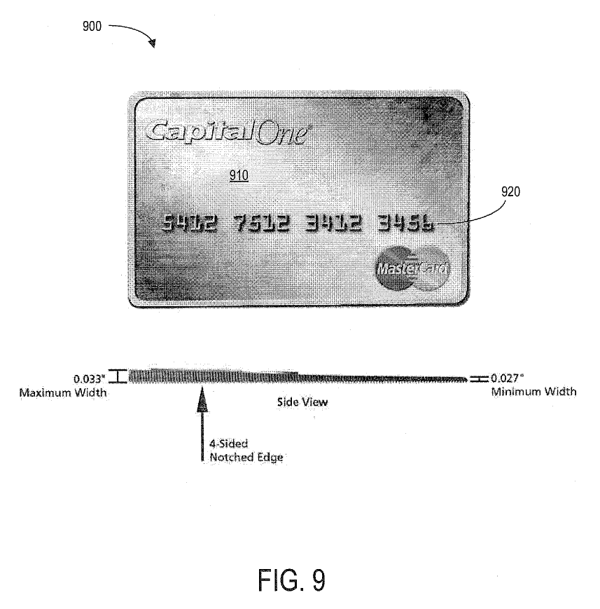

FIG. 9 is an illustration of a tapered payment card 900 in accordance with some embodiments of the present invention. The card includes a metallic card body 910 with a raised border creating a rim or picture frame effect and a payment card number 920 printed on the front surface (e.g., a raised payment card number 920 may be printed on the front face of the payment card).

The payment card 900 may also have notches (e.g., coin-like grooves) formed along substantially the entire lengths of all four card sides. Moreover, the payment card 900 is tapered such that a distance between the front and back faces proximate a first side is greater than a distance between the front and back faces proximate a second side opposite the first side (that is, the left side of the payment card 900 illustrated in FIG. 9 is thicker than the right side). Note that a card 900 may have, according to some embodiments, a brushed metal finish.

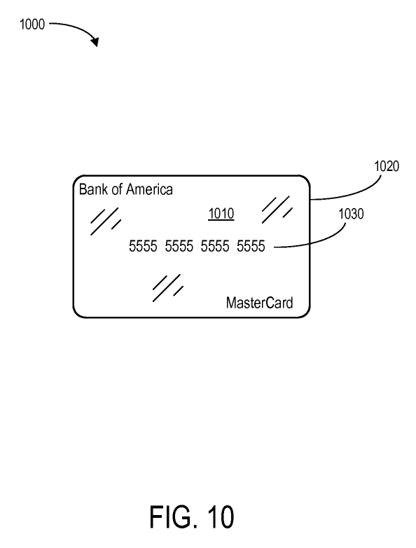

FIG. 10 is an illustration of a payment card 1000 in accordance with another embodiment of the present invention. In this example, the payment card 1000 includes a metallic card body 1010, a raised border 1020, and an area 1030 where a payment number is printed. According to some embodiments, the payment card 1000 has a treated metal, polished, reflective, burnished, pickled, and/or specially textured surface or finish. Such embodiments might, for example, also reduce the appearance of fingerprints on the surface of the card 1000.

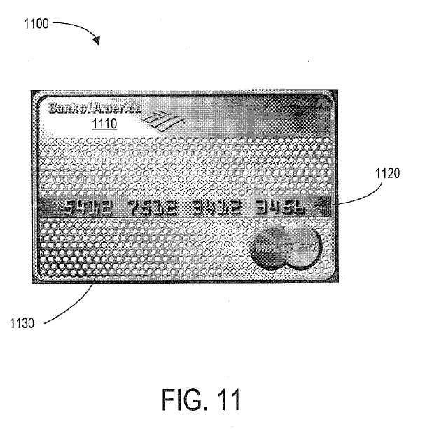

FIG. 11 is an illustration of a payment card 1100 in accordance with another embodiment of the present invention. In this example, the payment card 1100 includes a metallic card body 1110, a raised border, an area 1120 where a payment identifier is printed, and an array of punched-holes dimples 1130. Note that the area 1120 does not include punched-holes dimples 1130. As will now be described, such an area 1120 might be provided using a tray and insert arrangement.

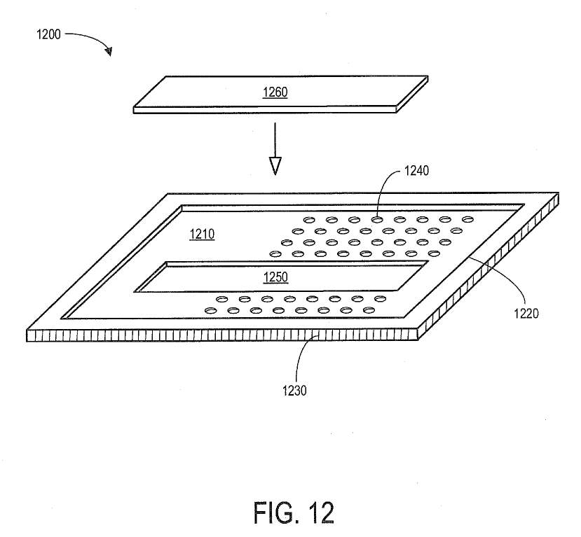

FIG. 12 is a perspective view of an identification card 1200 according to some embodiments of the present invention. The card 1200 has a substantially card-shaped body 1210 having a front face, a back face, and four card sides. Moreover, the card includes gripping elements, including a gripping border 1220 on the front face, notches 1230 along the side edges, and an array of dimple portions 1240 formed on a portion of the front face. According to this embodiment, the identification card 1200 further includes a tray portion 1250 formed on the main body 1210. The tray portion 1250 is adapted to receive an insert 1260 (e.g., the insert 1260 may placed and/or affixed within the tray portion 1250). The insert 1260 may be associated with, for example, a raised identification number representation number, a magnetic strip, and/or a Radio Frequency (RF) device.

To facilitate the production of identification cards, certain steps may be performed in connection with any of the embodiments described herein. Note that the description of these steps do not necessarily imply a fixed order to the actions, and embodiments may be performed in any order that is practicable. Further note that any of the methods described herein may be performed by hardware, software (microcode), or any combination of these approaches. For example, a storage medium may store thereon instructions that when executed by a machine result in performance according to any of the embodiments described herein.

For example, a card body may be formed for an identification card. The card body may be formed, for example, of plastic, metal, glass, or any other suitable substance. One or more gripping elements may be provided for the identification card. For example, a raised border may formed around the edge of a credit card and/or notches may be etched into the sides of the card.

Thus, embodiments described herein may let a user more accurately and more comfortably hold and manipulate an identification card (e.g., in relation to a card reader or other device). Moreover, embodiments may let a user know which type of card he or she is holding even without looking at the card.

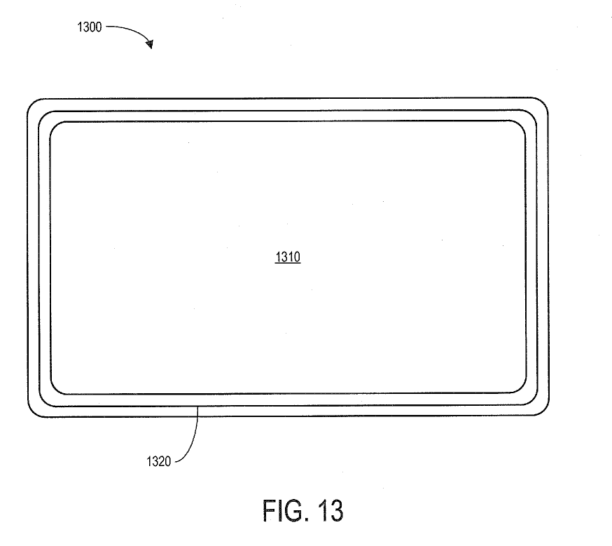

Although particular configurations have been described herein as examples, note that embodiments may be associated with any number of other types of configurations. For example, the raised borders illustrated in FIGS. 1 through 5 are located at the very outer edge of the identification card bodies. FIG. 13 is an top view of an identification card 1300 having card body 1310 and a gripping border 1320 offset from the card sides according to some other embodiments of the present invention.

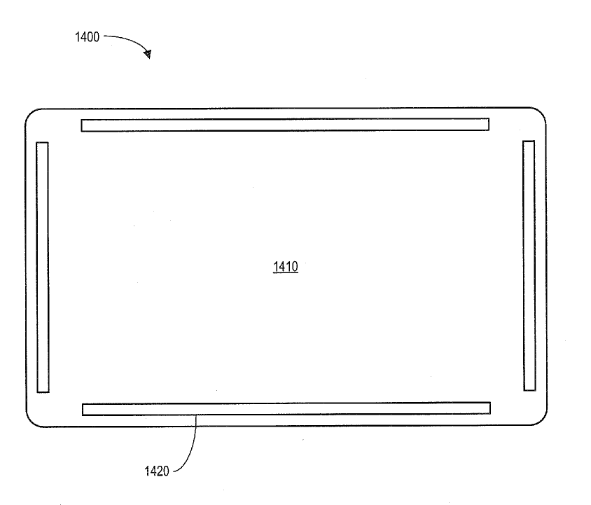

As another example, the raised borders illustrated in FIGS. 1 through 5 form contiguous frames around the card bodies. FIG. 14 is an top view of an identification card 1400 having a card body 1410 and a non-contiguous gripping border 1420 offset from the card sides according to still other embodiments of the present invention (e.g., the border 1420 is actually formed of four separate border portions, one along each side of the card body 1410).

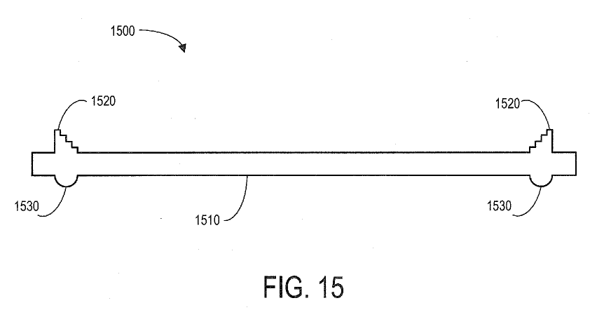

As yet another example, the raised borders illustrated in FIGS. 1 through 5 have generally rectangular cross-sections. FIG. 15 is a side cross-sectional view of an identification card 1500 having a card body 1510 and a first raised border 1520 having a step-shaped cross-section. The card body 1510 also has a second raised border 1530 having a curved-shaped cross-section.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. An identification card, comprising:
a substantially card-shaped body having a front face, a back face, and four card sides; and
a raised border portion, located on at least one of the front face or back face, the raised border portion being adjacent to and extending along at least one of the four card sides.

2. The identification card of claim 1, wherein raised border portions are provided on both the front and back faces of the identification card.

3. The identification card of claim 1, wherein the raised border portion forms a continuous frame extending along all four card sides.

4. The identification card of claim 1, wherein the raised border portion is formed integral with the card body.

5. The identification card of claim 1, wherein the raised border portion is affixed to the card body.

6. The identification card of claim 1, further comprising:
a plurality of notches formed on at least some of the four card sides.

7. The identification card of claim 1, further comprising:
an array of indented dimple portions, located on at least one of the front face or back face.

8. The identification card of claim 1, further comprising:
a tray portion to receive an insert, the tray portion being formed on the first face.

9. The identification card of claim 1, wherein the identification card is associated with at least one of: (i) a payment card, (ii) a credit card, (iii) a debit card, (iv) a loyalty program card, (v) a badge, (vi) a license, (vii) a passport card, (viii) a radio frequency apparatus, or (ix) a contactless card.

10. An identification card, comprising:
a substantially card-shaped body having a front face, a back face, and four card sides; and
a plurality of notches formed on at least some of the four card sides.

11. The identification card of claim 10, wherein the notches are formed as grooves in the card side that extend from the front face to the back face of the identification card.

12. The identification card of claim 11, wherein the notches are formed along substantially the entire lengths of all four card sides and further wherein the identification card is tapered such that a distance between the front and back faces proximate a first side is greater than a distance between the front and back faces proximate a second side opposite the first side.

13. An identification card, comprising:
a substantially card-shaped body having a front face, a back face, and four card sides; and
an array of indented dimple portions, located on at least one of the front face or back face.

14. The identification card of claim 13, wherein each dimple portion does not extend through the entire card body.

15. The identification card of claim 13, wherein each dimple portion extends through the card body from the front face to the back face.

16. The identification card of claim 15, wherein the card body and array of dimple portions form a mesh screen.

17. The identification card of claim 13, wherein the array of dimple portions covers substantially all of the front face or back face.

18. An identification card, comprising:
a substantially card-shaped body having a front face, a back face, and four card sides;
a gripping element, located on a first face of the front face or back face; and
a tray portion to receive an insert, the tray portion being formed on the first face.

19. The identification card of claim 18, further comprising:
the insert affixed within the tray.

20. The identification card of claim 19, wherein the insert is associated with a raised identification number representation number.

21. The identification card of claim 19, wherein the insert is associated with a magnetic strip.
